(19) United States
(12) Patent Application Publication
(10) Pub. No.: US 2008/0201285 A1
(43) Pub. Date: Aug. 21, 2008

(54) METHOD AND APPARATUS FOR DELIVERING NETWORK INFORMATION

(75) Inventor: Zhao Dai, Shenzhen (CN)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Tencent Technology (Shenzhen) Company Ltd., Shenzhen (CN)

(21) Appl. No.: 12/104,521

(22) Filed: Apr. 17, 2008

Related U.S. Application Data
(63) Continuation of application No. PCT/CN2006/002640, filed on Oct. 9, 2006.

(30) Foreign Application Priority Data
Dec. 21, 2005 (CN) 200510132413.6

(51) Int. Cl. G06F 17/00

(52) U.S. Cl. 706/45

(57) ABSTRACT

The embodiments of the present invention disclose a method for delivering network information, including: generating or updating user attribute information of a user according to user behavior data of the user; acquiring the user attribute information when the user uses a network service; and delivering network information to the user according to the user attribute information. The embodiments of the present invention further disclose an apparatus for delivering network information. The technical scheme of the embodiments of the present invention improves the precision of information targeting and saves network bandwidth and server resources.

### CROSS-REFERENCE TO RELATED APPLICATIONS

This is a continuation of International Application No. PCT/CN2006/002640, filed Oct. 9, 2006, which claims the priority benefit of Chinese Patent Application No. 200510132413.6, filed Dec. 21, 2005, the entire respective disclosures of which are incorporated herein by reference.

### FIELD OF THE INVENTION

The present invention relates to the field of telecommunication and computer technology, particularly, to a method and an apparatus for delivering network information.

### BACKGROUND OF THE INVENTION

Along with the popularization of the Internet and the development of information technologies, information on the Internet is booming beyond the conventional ways of delivering network information. The network information may include text, pictures and video covering network advertisements, news, entertainments and search entries. Currently two methods for delivering network information are adopted as the common ways:

1) the method of online information delivering: information is released on a network media to cover every user accessing the network media; the attributes and interests of users are not taken into consideration by this method, different users see the same information while accessing the website of the network media;

2) the method of context based information delivering: also called contextual delivering method; according to this method, the webpage contents currently viewed by a users are analyzed concerning the semantic significance of the webpage contents so that the information relating to the webpage contents is shown to the user.

It can be seen that current methods for delivering network information are developed around the network media, i.e., the website, and little attention is paid to in-depth analysis of user information, e.g., access habit, age, gender, interests of a user, etc. As a result, the information shown to the user may not be the precise information that the user wants but just interfering information, in other words, the precision and effect of information targeting are unsatisfactory. In addition, useless information occupies a large amount of network bandwidth and server resources, which is a considerable waste of network resources.

### SUMMARY OF THE INVENTION

Embodiments of the present invention provide a method and apparatus for delivering network information so as to solve such problems as unsatisfactory precision of network information targeting and the waste of network resources.

The technical scheme provided by the embodiments of the present invention is as follows.

A method for delivering network information includes:

generating or updating user attribute information of a user according to user behavior data of the user;

acquiring the user attribute information when the user uses a network service; and

delivering network information to the user according to the user attribute information.

An apparatus for delivering network information includes:

a first module, configured to generate or update user attribute information of a user recording to the user behavior of the user;

a second module, configured to acquire the user attribute information when the user uses a network service; and

a third module, configured to acquire information content matching the user attribute information acquired by the second module, and transmit the information content matching the user attribute information to a terminal of the user.

According to the technical scheme of the embodiments of the present invention, behaviors of the user enjoying services on the Internet, e.g., browsing web pages, using instant messaging tools, playing online games, etc., are analyzed, and user attribute information is generated according to the analysis of the behaviors of the user; information is shown to the user only when the type of the information to be delivered matches the user attribute information. In this way information highly relevant to the demands of the user may be provided for the user and the precision of network information targeting is thus improved. Furthermore, by adopting the technical scheme of the embodiments of the present invention, much less network bandwidth and server resources are occupied by useless information and a large amount of network bandwidth and server resources is saved.

### BRIEF DESCRIPTION OF THE DRAWINGS

FIGS. 1 and 2 are schematic diagrams illustrating the structure of an apparatus for delivering network information according to an embodiment of the present invention.

FIG. 3 is a flow chart illustrating the process of generating user attribute information according to an embodiment of the present invention.

FIG. 4 is a flow chart of delivering network information precisely according to an embodiment of the present invention.

### DETAILED DESCRIPTION OF THE INVENTION

The present invention is further described in detail hereinafter with reference to the accompanying drawings as well as embodiments so as to make the objective, technical solution and merits thereof more apparent.

The embodiments of the present invention include: generating user attribute information according to the behaviors of a user using Internet services and delivering relevant information according to the user attribute information.

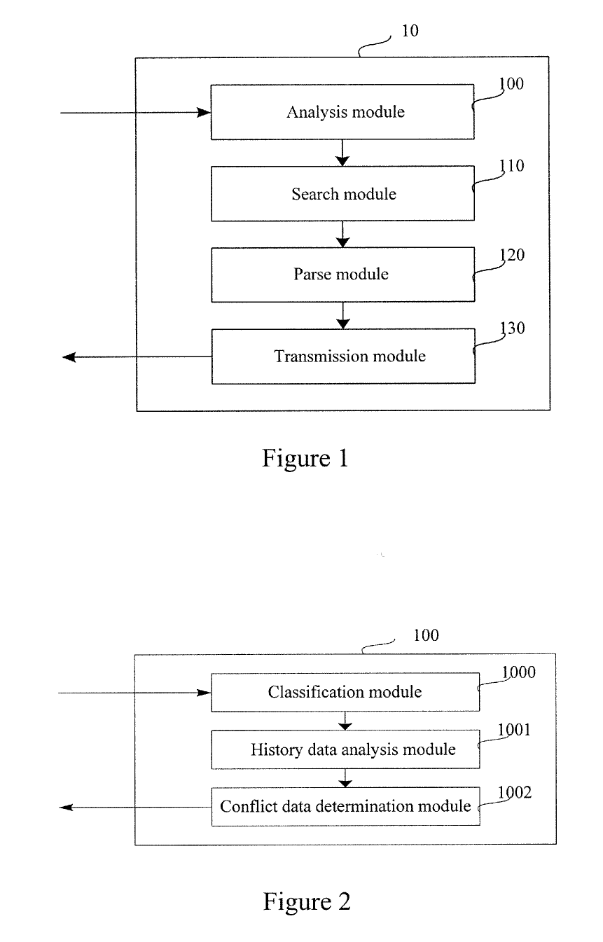

As shown in FIG. 1, an Apparatus 10, configured to deliver network information in accordance with an embodiment of the present invention, includes an Analysis Module 100, a Search Module 110, a Parse Module 120 and a Transmission Module 130.

The Analysis Module 100 is configured to collect and analyze the current behavior data and history behavior data of a user and further to generate or update user attribute information. Obviously, the user attribute information may be generated or updated according to the current behavior data of the user only.

The user attribute information may be stored in a user behavior habit database on the server side in a centralized manner, or be stored in a user computer on the client side in separate files or cookies, etc.

The Search Module 110 is configured to acquire a user identification of an online user and query, according to the user identification, the user behavior habit database or user attribute files and cookies on the client side to acquire the user attribute information. The user identification may be a logging ID, cookie and etc. of the user.

The Parse Module 120 is configured to match the user attribute information with a directional information delivering type in an information content database; if the matching succeeds, the Parse Module 120 acquires the information content corresponding to the directional information delivering type and transmits the acquired information content to the transmission module; if the matching fails, the process of the Parse Module 120 terminates.

The Transmission Module 130 is configured to transmit the information content acquired by the Parse Module 120 to the terminal used by the user so that the terminal displays the information content for the user.

In the embodiment of the present invention, the behavior data of the user includes the information of the user using Internet services, e.g., browsing web pages, using instant messaging tools, playing online games, etc. For example, the behavior data of the user may include user registration information, the information on the length of the time during which the user uses a service, information on the frequency and time point at which the user uses the service, information on value added services chosen by the user in relation to the current service, information on the channels visited by the user on a portal website and other information that reflects interests and preferences of the user. Obviously, the behavior data of the user may include a part or all of the information described above, or even more information that is not included herein.

The user behavior in Internet services is very complex; in order to extract the information to be delivered from the complex user behavior data, a user attribute model is adopted to express the user attribute information acquired by the Analysis Module 100. Table 1 shows an example of the user attribute model, and the attribute class in Table 1 may include a geographical attribute, a physiological attribute, a profession attribute and an interest attribute. New attributes may be added according to practical needs.

TABLE 1

| Attribute Class | Attribute Name | User Attribute Weight |
|---|---|---|
| Geographical Attribute | Beijing | |
| | Shanghai | |
| | Shenzhen | |
| | . . . | |
| Physiological Attribute | Age | |
| | Gender | |
| | . . . | |
| Profession Attribute | Industry | |
| | Income | |
| Interest Attribute | Real estate | |
| | Automobile | |
| | Cosmetics | |
| | Digital product | |
| | IT | |
| | . . . | |
| . . . | | |

As shown in Table 1, the attribute model classifies the attributes of target users of the information to be delivered and further classifies the users according to the attributes through a statistical measure; each of the attribute class is given a weight. In the user attribute model, the attribute classes are the key elements of the target users on which the information deliverer focuses. The elements may include the classes of the geographical attribute, physiological attribute, profession attribute and interest attribute, and each attribute class may further include sub classes. Because the user information may not be complete or totally reliable, the reliability of the user attributes is limited. In order to represent the reliability of the user attributes, each of the user attributes is given a weight with a range from 0 to 100, the weight equal to 0 indicates that the user attribute is totally unreliable and the weight equal to 100 indicates that the user attribute is absolutely reliable. Obviously, the user attributes may be not necessarily given the weight. If the user attribute model does not include attribute weights, all user attributes have the same weight.

As shown in FIG. 2, the Analysis Module 100 includes: Classification Sub-module 1000, History Data Analysis Sub-module 1001 and Conflict Data Determination Sub-module 1002.

The Classification Sub-module 1000 is configured to classify a user, i.e., put the user in the geographical attribute class, or the physiological attribute class, or the profession attribute class, or the interest attribute class according to the current behavior data of the user.

The History Data Analysis Sub-module 1001 is configured to store and analyze the history behavior data of the user. Since the persistent behavior of the user reflects the user preference more accurately than an accidental behavior does, the history behavior data of the user need to be analyzed and the interests and preferences of the user are analyzed through a statistical measure. The history data analysis sub-module is optional. If the history data analysis sub-module is not included in the apparatus of the embodiment of the present invention, the analysis module does not analyze the history behavior data of the user but the current behavior data of the user only.

The Conflict Data Determination Sub-module 1002 is configured to determine whether behavior data conflict with each other. When behavior data from different channels conflict with each other, a preset priority order is adopted to determine which data should be kept. For example, behavior data usually have a higher priority than static attribute data, because the user may leave false registration information. A more accurate conclusion may be drawn by analyzing the user behavior in using value added services and accessing channel contents. For example, a user may register as a male; it is discovered through statistics that the user often browses cosmetics and nursery channels, then a conclusion may be drawn that the user is actually a female.

The user attribute information acquired by the Analysis Module 100 is stored in the user behavior habit database. Information is delivered to the target users according to the data in the user behavior habit database. The data may be stored in the user behavior habit database in a manner shown in Table 2.

TABLE 2

| Data Class | Value |
|---|---|
| Geographical Location | Beijing |
| Gender | Male |
| Age | 25-30 |
| Interest | Real estate, automobile |
| Profession | Service industry |
| Income | 3000-5000 |

The information to be delivered is stored in the information content database which includes raw information materials, information redirect links and directional information delivering types. The directional information delivering types include types of geographical location, gender, age, interest, profession, income, etc. The information contents may be inputted by information deliverers or by operators of the information system.

In order to show information matching the interest and preference of the user, the Search Module 110 searches the user behavior habit database to acquire the interest and preference of the user; then the Parse Module 120 searches the information content database to acquire the information to be delivered via the matching between the information to be delivered and the directional information delivering type.

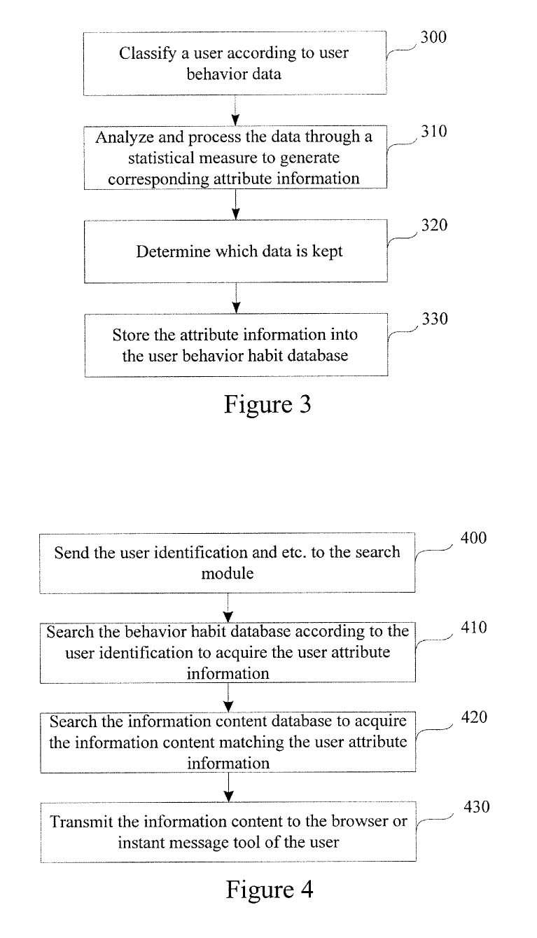

FIG. 3 shows the process of generating user attribute information after collecting behavior data of a user in accordance with the technical scheme of an embodiment of the present invention.

Block 300: A user is put into a class, e.g., the class of geographical attribute, physiological attribute, profession attribute or interest attribute, according to the behavior data of the user.

Block 310: The behavior data collected this time and the history behavior data collected previously are analyzed and processed through a statistical measure to generate corresponding user attribute information. Obviously, the user attribute information may be generated according to the analysis and statistics of the behavior data collected this time only.

Block 320: It is checked whether some data conflict with other data; if some data conflict with other data, a principle, i.e., behavior data have a higher priority than static attribute data, is adopted to determine which data should be kept.

Block 330: The user attribute information is stored. The user attribute information is stored on a user-by-user basis.

As shown in FIG. 4, the flow of delivering precise information mainly includes the following processes.

Block 400: Acquire a user identification of the user when the user uses Internet services. The user identification may be a logging ID of the user or Cookie on the user terminal.

Block 410: Acquire the user attribute information, e.g., geographical attribute, physiological attribute, profession attribute or interest attribute, from the user behavior habit database on the server side, or from attribute files, or from cookies on the user terminal according to the user identification.

A threshold may be preset. The weight of an attribute may be taken into consideration in the choice of the attribute, e.g., if the weight is lower than the threshold, the attribute does not be chosen.

Block 420: Search the information content database according to the user attribute information to acquire the information content matching the user attribute information.

A number of policies may be adopted in the matching process, e.g., acquire the information content that matches the most attributes, or acquire the information content that matches an attribute with the highest weight, or acquire the information content that matches an attribute with the highest reliability.

Block 430: The information content matching the user attribute is transmitted to the user terminal and show the information content on the user terminal.

The embodiment of the present invention provides customized, directive and valuable information for a user by means that behavior habits of the user in Internet services, e.g., browsing web page, using instant message tools, playing online games, etc., are collected and analyzed via a statistical measure, therefore the precision of delivering network information and the effect of delivering network information are improved.

To sum up, the foregoing is only preferred embodiments of the present invention and is not for use in limiting the protection scope thereof. Any modification, equivalent replacement and improvement made without departing from the spirit and principle of the present invention should be included in the protection scope thereof.

What is claimed is:

1. A method for delivering network information, comprising:
generating or updating user attribute information of a user according to user behavior data of the user;
acquiring the user attribute information when the user uses a network service; and
delivering network information to the user according to the user attribute information.

2. The method of claim 1, wherein generating or updating the user attribute information of the user according to the user behavior data of the user comprises:
analyzing user behavior data of the user from different channels; the user behavior data of the user from different channels comprises at least one of user behavior data collected currently and history user behavior data collected previously;
checking whether the user behavior data of the user from different channels conflict with each other; if the user behavior data of the user from different channels conflict with each other, determining which user behavior data of the user are kept according to a principle that behavior data have a higher priority than static attribute data;
generating or updating the user attribute information of the user according to the kept user behavior data of the user.

3. The method of claim 2, further comprising:
storing the user attribute information on a user-by-user basis.

4. The method of claim 1, wherein acquiring the user attribute information when the user uses the network service comprises:
acquiring a user identification of the user when the user uses the network service;
acquiring the user attribute information according to the user identification;
delivering the network information to the user according to the user attribute information comprises:
searching an information content database according to the user attribute information and acquiring the information content matching the user attribute information;
transmitting the information content matching the user attribute information to a terminal of the user and showing the information content on the terminal.

5. The method of claim 4, further comprising:
setting up a weight value for the user attribute information, and setting up a matching threshold; wherein
acquiring the information content matching the user attribute information comprises:
checking whether the weight value of the user attribute information is higher than the matching threshold;
acquiring the information content matching the user attribute information if the weight value of the user attribute information is higher than the matching threshold.

6. An apparatus for delivering network information, comprising:
a first module, configured to generate or update user attribute information of a user according to the user behavior of the user;
a second module, configured to acquire the user attribute information when the user users a network service; and
a third module, configured to acquire information content matching the user attribute information acquired by the second module, and transmit the information content matching the user attribute information to a terminal of the user.

7. The apparatus of claim 6, wherein the first module comprises:
a first sub-module, configured to analyze user behavior data of the user from different channels; the user behavior data of the user from different channels comprises at least one of user behavior data collected currently and history user behavior data collected previously;
a second sub-module, configured to check whether the user behavior data of the user from different channels conflict with each other; if the user behavior data of the user from different channels conflict with each other, determine which user behavior data of the user are kept according to a principle that behavior data have a higher priority than static attribute data;
a third sub-module, configured to generate or update the user attribute information of the user according to the kept user behavior data of the user.

8. The apparatus of claim 6, wherein the third module comprises:
a fourth sub-module, configured to acquire the information content matching the user attribute information acquired by the second module; and
a fifth sub-module, configured to transmit the information content matching the user attribute information to a terminal of the user.

9. The apparatus of claim 6, wherein the user attribute information is stored on a user-by-user basis in a server or a terminal of the user.
